(19) United States
(12) Patent Application Publication
(10) Pub. No.: US 2010/0221085 A1
(43) Pub. Date: Sep. 2, 2010

(54) Monarch anchor

(76) Inventor: Mohiuddin Ahmed Chowdhury, Corona, CA (US)

Correspondence Address: Mohiuddin Ahmed Chowdhury, 6760 Black Forest Drive, Corona, CA, 92880, US

(21) Appl. No.: 12/380,562

(22) Filed: Mar. 2, 2009

(51) Int. Cl. F16B 13/04; E04G 21/12

(52) U.S. Cl. 411/33; 52/745.21

(57) ABSTRACT

The Monarch anchor is a nut & bolt system specially designed to be pushed through a hole wide enough to allow the bolt with collapsed wings fitted at its back end through, but not wide enough to let the bolt with stretched wings slip back. It is designed to be firmly placed on the wall with the front end of the outer nut locked at the front surface of the wall by a flange and the stretched wings locked at the back surface of the wall. Thus it can act as a firm support on the wall when an item is bolted through the inner nut of the anchor.

### BACKGROUND OF THE INVENTION

This invention is a device useful for attaching any item strongly and durably to drywall or other hollow walls. It has 2 collapsible wings that can be introduced behind the wall through a narrow opening purposely made in the wall. The wings are designed to spread spontaneously behind the wall. Another feature of the device is a threading system for pulling the stretched wings toward the back surface of the wall. Once they are pulled tightly enough the wings lock on the back surface of the wall because the wing span is much greater than the diameter of the opening. Thus the fully stretched wings act like a brace behind the wall.

As the wings lock, an elongated nut attached to the wings can be used for securely fastening an item to the wall. In the case of the walls made of gypsum panels, the attachment is much stronger than what could be achieved with ordinary screws. For other types hollow walls the device may be the only means of bolting an item to the wall.

### BACKGROUND OF THE INVENTION—DISCUSSION OF PRIOR ART

Since the 1920s houses have commonly employed drywalls for making interior walls and ceilings. For the purpose of making the interior walls, the drywalls are supported by 2×4 vertical wooden studs that are usually spaced 16 inches apart. Many items are attached to or hung from these walls and ceilings, and some of these items add to the decor of the rooms. Pictures, paintings, curtains, mirrors, shelves, planters, and many other examples abound. A number of items like shower curtain rods, toilet paper holders, wall-desks etc. are placed on these drywalls for specific functions. These functional items often involve tensions in addition to the gravitational one, for example, being pulled away or jerked from the attachment.

The drywalls are made of rather soft materials. They can be easily cut even with a plastic knife or easily pierced with ordinary push-pins. The usual thickness of the drywalls is only a half of an inch. In many older houses it is even thinner. Because of the intrinsically low strength and the small thickness, drywalls cannot support any item strongly. Therefore, if the item is heavy or requires stability against pulling etc. it should ideally be attached to an existing wooden stud.

The precise position of an item on the wall or ceiling is strongly dictated by many considerations, like aesthetics, decor, functionality etc., rather than by the availability of a stud. Even in the cases where a wooden stud is at the right place, difficulty arises due to problems with finding this stud behind the drywall.

The stud sensors can be laser-guided, electronic or simply mechanical. However, even the sophisticated stud sensors often give faulty signals. The user routinely finds that there is no stud behind the spot indicated by the sensor. Even when a stud is sensed correctly, the user has to guess about the center of the stud and often places the screw/anchor at an unacceptable edge of the stud, resulting in a very weak support. Finally, even the perfect stud sensor is of no use if the appropriate spot for the item is significantly away from the existing studs of the house.

When the stud is not practical one commonly tends to use plastic anchors. Since plastic is stronger than the material of drywall, it is hoped that when embedded in the drywall the plastic anchors add to the strength of the support. These anchors involve drilling a hole in the drywall with a power drill. The anchor is then hammered into this hole. The anchor has a through-hole designed to accommodate a threaded fastener. An item held by this threaded fastener is still really being supported by the drywall only. The same stress that could bring the item down usually brings down the anchor and with it, the item itself.

Regarding these anchor bolts, West et al. (U.S. Pat. No. 6,186,786 on Feb. 13, 2001 and U.S. Pat. No. 6,354,779 on Mar. 12, 2002) addressed the problem associated with the hole. Making a hole with a drill carries the risk of drilling a hole that is too wide to hold the anchor bolt snugly. The self drilling anchor bolt of West et al. eliminates the need for using a drill. The real advantage of this device is that the hole is of the right size and therefore the anchor is installed perfectly every time. However, it does not even address the issue that the anchor is still a very weak support.

The Grip+® Drywall screws have specially designed grooves for improved strength of grabbing the drywall material. In practice, this device also adds only a little strength to the support. Even light items supported by these screws soon come off the wall if they are regularly subjected to a certain amount of tension, any kind of movement or if they are hit accidentally by anything. Only the ugly hole on the wall persists.

Two other items of prior art deserve special discussion here because this invention can be considered as a combination of these two fasteners. The combination accomplishes the purpose of either of them while eliminating the problems associated with both of them. These fasteners are
1. Metal anchors like molly bolts
2. Toggle bolts

### Metal Anchors Like Molly Bolts

The superiority of metal anchors, for example, Wej-It Acorn Nut Sleeve Anchors, similar to commonly known Molly bolts, lies in the fact that the support involves a piece of the drywall material rather than drywall dust. These anchors have metal strips that are designed to be bent into prongs. The prongs can lock and thus fix a nut against the back-surface of the wall/ceiling. The strength of support comes not from the metal, but from the fact that the fully extended prongs grab a larger area and therefore a larger amount of the drywall material than that grabbed by plastic anchors or drywall screws discussed above.

The force needed for bending the metal strips into prongs is applied by pulling a nut by screwing a bolt into the nut. Therefore, installation of this system involves bending of strong metal strips while being at a considerable disadvantage of having to apply the force indirectly. Consequently, it involves a very large amount of force. Most users find it significantly difficult to manually install these anchors on a drywall.

If one uses an electrical bolt-driver to apply the force, one is prone to apply excessive force that results in drilling the entire stem of the anchor through the drywall. The entire nut/bolt falls off behind the drywall and is lost forever. The user gets no support in the desired spot. Instead he or she gets only an unsightly hole at that position. Once this happens, the hole is too big for using another anchor at or very near that spot.

### Toggle Bolts

A toggle bolt is equipped with a folding anchor that has a nut in the middle. The folded anchor can be passed through a small hole. It spontaneously opens up behind the drywall. As the bolt is fully tightened, the opened anchor firmly locks itself against the back-surface of the drywall.

This system requires an ordinary amount of force for installation. It is useful for attaching a hook that is usually a part of the bolt itself. Consequently, the system is useful for items that can be hung from a hook.

However, most of the household items need attachment directly with the bolt. For these purposes, these bolts and anchors need to be properly assembled at the fastening-points of the item before the folded anchors are passed through the drywall. Except for very light and very compact items, locking of the anchor while the item is coupled with system is a very inconvenient process. Therefore this system is impractical for most items.

Also, after the item is installed the bolts must remain screwed. If, for any reason, for example, any readjustment in the item, a bolt is completely unscrewed, the anchor falls off and the support is lost. Since many items require multiple bolts, one has to undo the remaining bolts as well and repeat the inconvenient procedure described above.

### Patent Search

Search for drywall anchors has yielded several other devices besides the two mentioned above. These are U.S. Pat. No. 6,920,988 to Ratliff on Jul. 26, 2005, U.S. Pat. No. 6,669,034 to Diedrichsen on Dec. 30, 2003, U.S. Pat. No. 6,406,233 to Shaner on Jun. 18, 2002, U.S. Pat. No. 6,357,608 to Timm on Mar. 19, 2002, U.S. Pat. No. 6,082,560 to Timm on Jul. 4, 2002, U.S. Pat. No. 5,794,903 to Peterson II on Aug. 18, 1998, U.S. Pat. No. 5,123,129 to Lyons on Jun. 23, 1992 and U.S. Pat. No. 4,953,261 to Lyons on Sep. 4, 1990. However all of these involve external anchors for items like towel bar, closet shelves, free-standing furniture etc. The Retro-Stud acts as a concealed internal anchor for a wide variety of items that are supported directly on the wall or from the ceiling. Therefore, a discussion of these patents is not relevant to this invention.

### BACKGROUND OF THE INVENTION—OBJECTS AND ADVANTAGES

The object of Monarch Anchor is to provide a strong and durable support for any item on the drywall or hollow walls in general. The support is as strong as that provided by the molly bolts or toggle bolts and is therefore adequate for almost any household item. Yet it is far easier to install than the molly bolts. Unlike toggle bolts it does not need to be assembled to the item prior to attaching of the item to the wall.

It eliminates the need for having an existing stud for fastening an item. There is no need to look for the stud with a stud sensor. There is no risk of drilling a hole unnecessarily on the drywall because the sensor has spuriously indicated a stud.

### SUMMARY

The Monarch Anchor is an anchor for hollow walls. It consists of 2 parts, namely, Monarch nut and Monarch bolt. The Monarch nut is an elongated nut with threads on the inner wall and a flange at the front end. The Monarch bolt has threads on the outer wall that fit the Monarch nut. Monarch bolt has through-hole with threads on the internal wall. Another special feature of the Monarch bolt is a pair of collapsible wings fitted at its back end. For installing the anchor one first makes a hole in the wall. Then the Monarch bolt is threaded only a few turns into the back end of the Monarch nut. This assembly is then pushed across the hole with the wings first. The wings collapse and pass through the hole. When the assembly is pushed all the way 2 situations arise. 1. The Monarch nut sits firmly on the wall, being prevented from going through by the flange; and 2. The unthreaded portion of the Monarch bolt and the wings are behind the wall where the wings spontaneously open up. In the next step the monarch bolt is screwed towards the front of the wall until the wings lock against the back surface of the wall. Thus The Monarch anchor provides a strong support at the desired spot/area on the drywall for items that are significantly heavy and/or require stability against movement. One simply needs to bolt the item using the inner threads of the Monarch bolt.

### DRAWINGS

FIG. 1: Schematic diagram of the Monarch nut

FIG. 2: Schematic diagram of the Monarch bolt with collapsible wings—top view

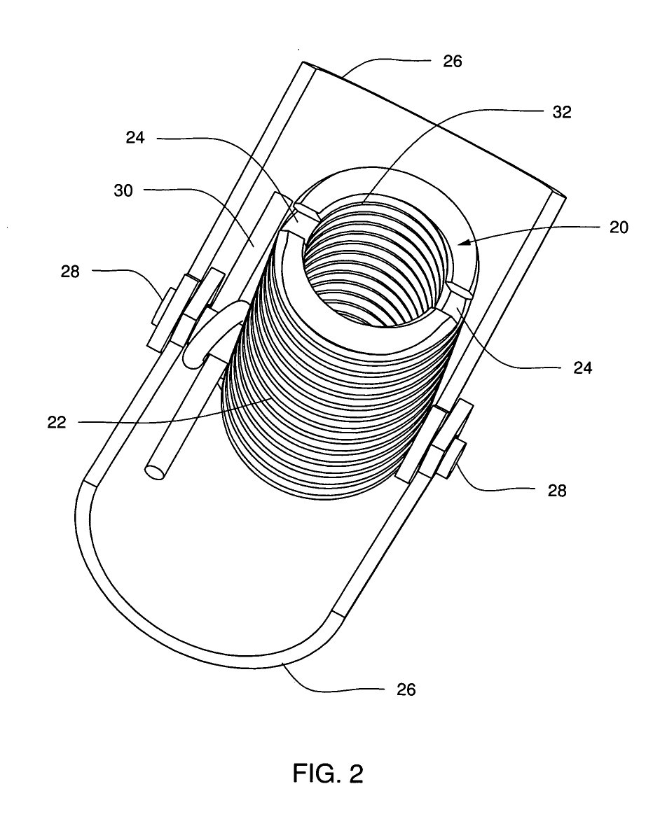

FIG. 3: Schematic diagram of the Monarch bolt with collapsible wings—lateral view

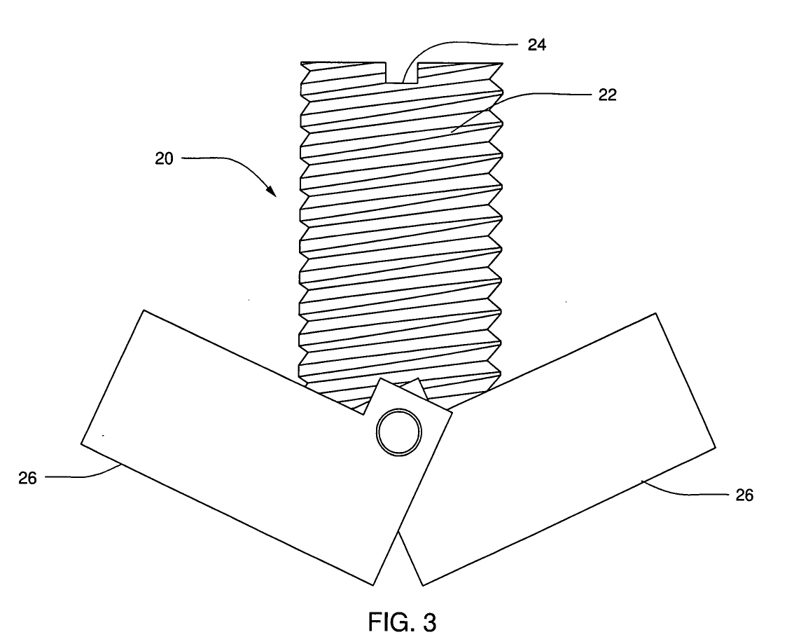

FIG. 4: Schematic diagram of the Monarch bolt with the wings collapsed—lateral view

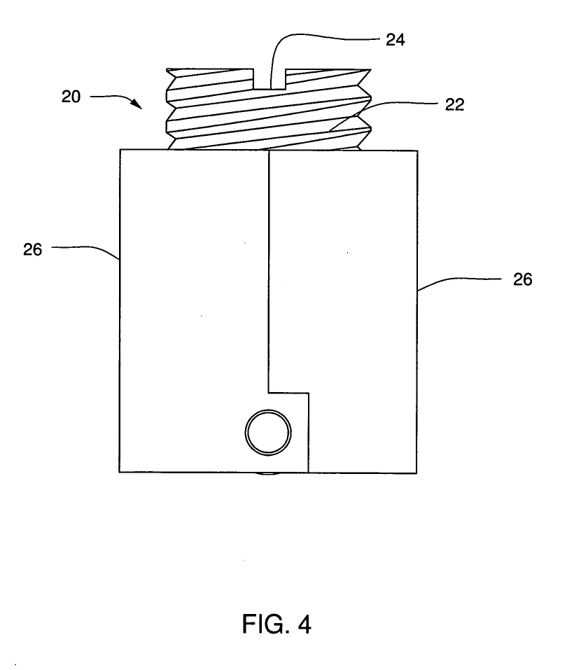

10 body of the Monarch nut
12 thread on the inner wall of the Monarch nut 10
14 flange at the front end of the Monarch nut 10
20 body of the Monarch bolt
22 thread on the outer wall of the Monarch bolt that matches the thread 12 on the inner wall of the Monarch nut 10
24 groove on the edge of the front of the Monarch bolt for accommodating screw driver tip
26 wing structures
28 posts for pivoting the wing structures 26
30 flexible wire that allows the wings 26 to collapse under pressure, flipping back open when the pressure is released
32 thread on the inner wall of the Monarch bolt 20

### Operation

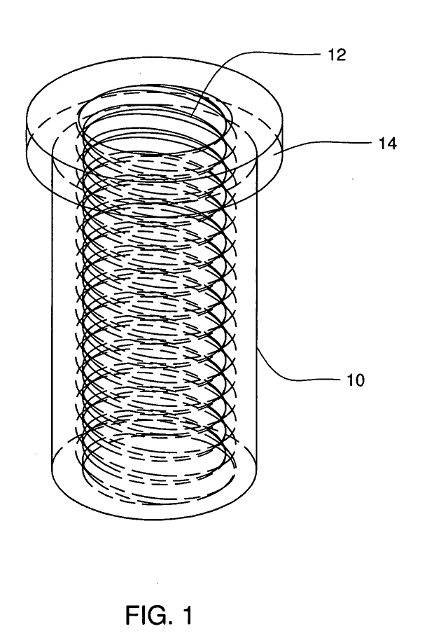

The current embodiment of Monarch Anchor has 2 components. The first component is called Monarch nut 10. As shown in FIG. 1 it is an elongated nut with threads 12 on the inner wall and a flange 14 at the front end. Thus the diameter of the front end of Monarch nut is slightly larger than that of the body of the nut.

The component 2, called Monarch bolt is another elongated tube 20 with threads 22 that match the threads 12 of the Monarch nut 10. Unlike ordinary bolts the Monarch bolt 20 can be considered as headless. However, it 20 has grooves 24 at the edge of the front end for accommodating a screw driver tip.

A special feature of the Monarch bolt 20 is a pair of wings 26 of suitable material and dimensions. These structures 26 are coupled to the back end of bolt 20 via 2 posts 28. These posts 28 act as pivots. A spring coil 30 placed between the wings allow the wings to collapse across the pivots 28 and relax back to fully stretched position when the collapsing force is absent.

Another special feature of this bolt 20 is that it is tube-like and has threads 32 on the internal wall. Thus the Monarch bolt 20 can also function as a nut for the appropriate ordinary bolts.

To operate the device the user drills a hole in the wall at the desired position. The diameter of the hole must be equal to the diameter of the body of the Monarch nut 10, but less than the diameter of the flange 14. The nut 10 and the bolt 20 are assembled by threading the front end of the bolt 20 just a few turns into the back end of the nut 10. A sufficient length of bolt 20 must remain outside the nut 10 for allowing the wings 26 to be collapsed onto the body of bolt 20 without touching any part of the nut 10.

This assembly is pushed into the hole, wings 26 first. As it advances the wings 26 remain collapsed by the pressure from the wall of the hole. It is pushed until the nut 10 sits firmly in the hole, being prevented from going farther by the flange 14. At this position unthreaded portion of the bolt 20 and the wings 26 are completely past the hole and the wings 26 are stretched fully open by the spring coil 30. Then the user moves the bolt 20 counterclockwise with a screwdriver. This brings the bolt 20 towards the front of the wall and with it, the stretched wings 26 closer to the back surface of the wall. The installation of the Monarch anchor is complete when the bolt 20 is moved enough such that the fully stretched wings 26 sit tightly against the back surface of the wall. The span of the fully stretched wings 26 can be made far greater than the diameter of the hole in the wall. Consequently, the stretched wings 26 cannot slip out through the hole. Instead they 26 sit tightly against the back surface of the wall and act as a strong brace.

In the final step, the user bolts the item to be hung using the inner thread 32 of the Monarch bolt 20.

Caution: protective eye-wear is recommended for installation of the Monarch Anchor

### CONCLUSION, RAMIFICATIONS AND SCOPE

The Monarch anchor forms a support at a spot on drywall where no stud previously existed. It is capable of being attached firmly on a wall or ceiling made of standard drywall material. Thus it forms strong support for heavy items that the drywall itself cannot support for a sufficiently long time. It is also superior to other available systems for the same purpose.

The principal advantage of the Monarch anchor is the ease of installation, specially compared to molly bolts. After installing the Monarch anchors at the appropriate spots, hanging of an item on the wall becomes as easy as putting the item up on the wall and screwing the few bolts to the anchors. Because of the anchors the support is far stronger than if the above step were done simply on the drywall. When hung with couple of Monarch anchors, the support is adequate for almost any household item.

I claim:

1. A method of firmly placing an anchor system in hollow walls by the steps of
a. inserting through a hole in the said wall in the proper direction a plurality of components, of which one back component is fitted with structures capable of being collapsed with minimal force, and
b. passing said plurality of components through the said hole in the said wall with the said structures in the collapsed position until a front component of the said plurality of components is firmly locked against the front surface of the said wall by a stopping means, subsequently
c. moving the said back component towards the front of the said wall by a maneuvering means, whereby
d. the said structures which spontaneously have stretched back into open position upon reaching behind the said wall, lock against the back surface of said wall, thus providing,
e. a firmly set anchor containing a fastener means for attaching objects durably to the said wall.

2. A method of claim 1 where the stopping means consists in the front end of said front component being larger in dimension than that of the body of the said front component.

3. A method of claim 1 where the maneuvering means consists in 1. said back component having i) bolt-like threads on the outer wall and ii) plurality of grooves at the front edge for accommodating screw driver tips, and 2. said front component having nut-like threads on the inner wall that match said bolt-like threads of said back component.

4. A method of claim 1 where said fastener means consists of nut-like threads on the inner wall of said back component.

5. A device capable of being firmly placed in hollow walls, comprising of
a. a front component with a maneuvering means for anther component to move back and forth while coupled to the said front component, and
b. said front component having a stopping means for being firmly set against front surface of said wall, and
c. a back component fitted with a structure or plurality of structures that is/are capable of collapsing under minimal force and stretching back when the said force is withdrawn, and
d. said front component and said back component, upon being assembled in the proper manner, are capable of passing through a small hole in the said wall in the proper direction, such that
e. all parts of said front component except a small part in the front end are in the said hole and the said small part in the front end is locked against the front surface of the said wall by a stopping means, and
e. the said structure/plurality of structures of said back component is/are completely behind the said wall and therefore is/are fully stretched, whereby
f. upon moving the said back component in the proper direction along the said front component by the said maneuvering means the said structure/plurality of structures can be locked against the back surface of said wall, thus providing
g. a firmly set anchor containing a fastener means for attaching objects durably to the said wall.

6. A device of claim 5 where the maneuvering means consists of 1. said back component having i) bolt-like threads on the outer wall and ii) plurality of grooves at the front edge for accommodating screw driver tips, and 2. said front component having nut-like threads on the inner wall that match said bolt-like threads of said back component.

7. A device of claim 5 where the said stopping means of said front component is like a flange.

8. A device of claim 5 where said fastener means consists of nut-like threads on the inner wall of said back component.
